(19) United States
(12) Patent Application Publication
(10) Pub. No.: US 2017/0045180 A1
(43) Pub. Date: Feb. 16, 2017

(54) Height-Adjustable Survey Tripod Assembly

(71) Applicant: Michael Edward Schaeffer, Atlanta, TX (US)

(72) Inventor: Michael Edward Schaeffer, Atlanta, TX (US)

(21) Appl. No.: 14/822,572

(22) Filed: Aug. 10, 2015

(51) Int. Cl. F16M 11/24; F16M 11/16; F16M 11/04

(52) U.S. Cl. CPC F16M 11/24; F16M 11/046; F16M 11/16

(57) ABSTRACT

A survey tripod assembly kit is disclosed that is easily adjustable in small increments to stable operational heights ranging from a few inches to eight feet or more and that can be easily disassembled and packed into a luggage-sized carrying case that is easily transportable from site to site. The subject survey tripod assembly desirably includes an instrument support plate, a plurality of cooperatively engageable leg sections comprising at least three leg sections of each of a plurality of different lengths that are each configured to be joined in threaded engagement to another leg section or to the instrument support plate, and three swiveling adjustable feet that are each configured to be joined in threaded engagement with at least one leg section or with the instrument support plate. A survey tripod assembly made from the subject kit is also disclosed.

### FIELD OF THE INVENTION

This invention relates to a height-adjustable support device for survey instruments, and more particularly to a tripod assembly kit having a plurality of leg components that can be joined together in various combinations to make a survey tripod assembly so as to adjust the height of a plate onto which a survey instrument is or can be mounted. The subject device comprises swiveling adjustable feet for leveling to gravity and can be conveniently disassembled and packed into a carrying case for transport following use.

### DESCRIPTION OF RELATED ART

Conventional tripods intended for use in supporting survey instruments, photographic equipment, weapons, and the like, are well known. Historically, survey tripods were made with three wooden legs of fixed length that were hinged to a support plate attachable to a survey instrument and were height-adjustable primarily by spreading the legs outwardly relative to each other. More recently, tripods have been made using other materials, such as aluminum or metal alloys, and with legs having telescoping or otherwise extendable leg sections held in place by clamping devices of various types. Pointed metal tips or stakes are sometimes provided at the bottom of each leg to resist wear and to facilitate contact with and penetration into an underlying surface to enhance stability. Conventional survey tripods are typically configured for use at operational heights ranging from about four to six feet above ground level and are not collapsible to overall lengths less than about four feet.

Prior patents disclosing surveyor tripods and ancillary pole supports include, for example, U.S. Pat. Nos. 4,192,076; 4,366,940; 4,641,804 5,622,344; 7,048,241; 7,124,985; 7,207,534; 7,222,827; 7,240,881; and 7,374,140.

### SUMMARY OF THE INVENTION

A survey tripod assembly kit is disclosed that is easily adjustable in small increments to stable operational heights ranging from a few inches to eight feet or more and that can be easily disassembled and packed into a luggage-sized carrying case that is easily transportable from site to site. The subject survey tripod assembly desirably includes an instrument support plate, three legs each comprising a plurality of cooperatively engageable leg sections in each of a plurality of different lengths, and at least three swiveling adjustable feet. The leg sections are each desirably configured to be releasably attachable to another leg section, or to the instrument support plate, or to one of the three swiveling adjustable feet. For some uses with very low operational heights, no leg sections are required and the swiveling adjustable feet are directly attachable to the underside of the instrument support plate. The instrument support plate of the subject survey tripod assembly desirably further comprises a survey instrument attachment device, a plurality of threaded receptacles each releasably engageable with a leg section at a predetermined attachment angle. According to another embodiment of the invention, the subject survey tripod assembly comprises at least one optional vertical extension member releasably engageable with the instrument support plate to elevate a survey instrument above the instrument support plate.

The survey tripod assembly of the invention is mechanically strong and stable, without relying on axially extending slip joints, compression clamps, folding hinges, or the like. Each of the three legs of the survey tripod assembly of the invention desirably comprises a plurality of leg sections having different lengths that are intended to produce a tripod assembly that can be configured in a variety of different tripod heights to accommodate various environments and conditions of use. By combining various numbers and lengths of leg sections, users can achieve many different operational height adjustments in relatively small increments, generally 2-3 inches or less, especially when taking into consideration the threaded adjustments on the swiveling feel at the base of each leg. Following use, the subject invention is easily disassembled and can be packed and transported inside a carrying case no larger than a conventional piece of luggage.

### BRIEF DESCRIPTION OF THE DRAWINGS

The apparatus of the invention is further described and explained in relation to the following drawings wherein:

FIG. 1 is a front elevation view of one embodiment of the survey tripod assembly of the invention with a survey instrument that forms no part of the invention shown in dashed outline;

FIG. 2 is an exploded view of one embodiment of an instrument support plate that is supported by the three legs of the survey tripod assembly of the invention;

FIG. 3 is a top plan view of the assembled instrument support plate of FIG. 2 with the survey instrument attachment device installed;

FIG. 4 is a front elevation view of the assembled instrument support plate of FIG. 3;

FIG. 5 is cross-sectional front elevation view taken along line 5-5 of FIG. 3;

FIG. 6 is a front elevation view of one embodiment of a leg section of the invention;

FIG. 7 is a cross-sectional front elevation view taken along line 7-7 of FIG. 5;

FIG. 8 is a perspective view of elements included in one embodiment of the survey tripod assembly kit of the invention; and

FIG. 9 is a front elevation view of an assembled survey tripod assembly having two vertical extension sections attached by the survey instrument attachment device to the instrument support plate.

### DESCRIPTION OF THE PREFERRED EMBODIMENTS

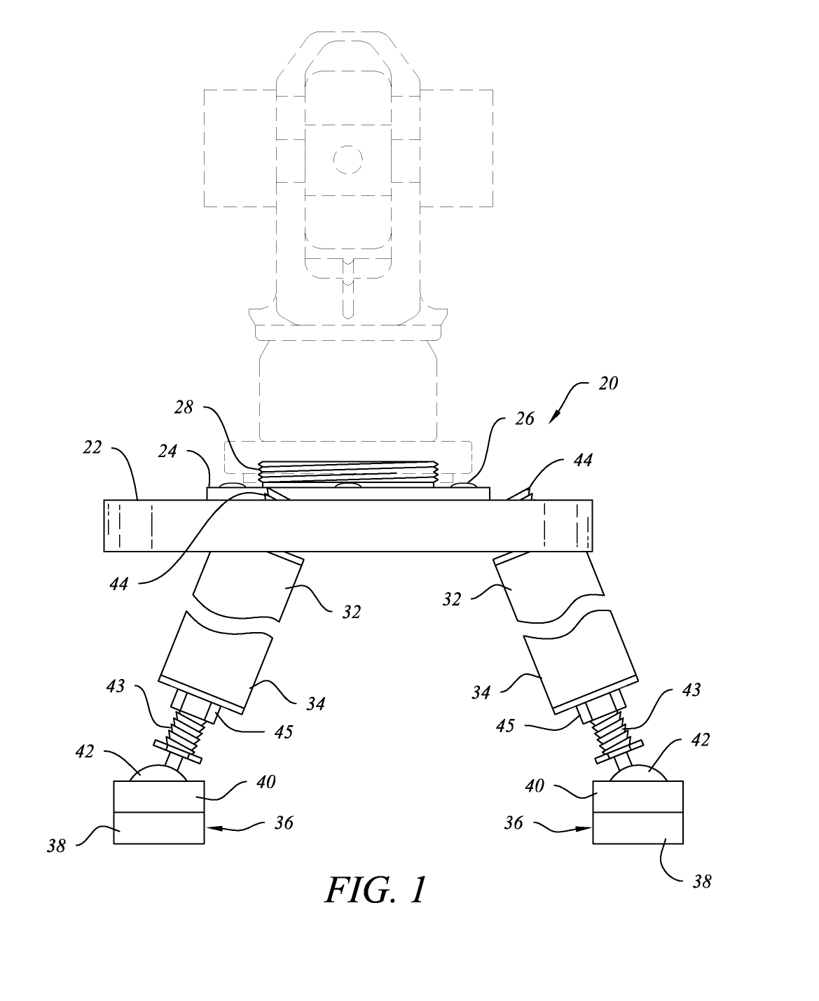

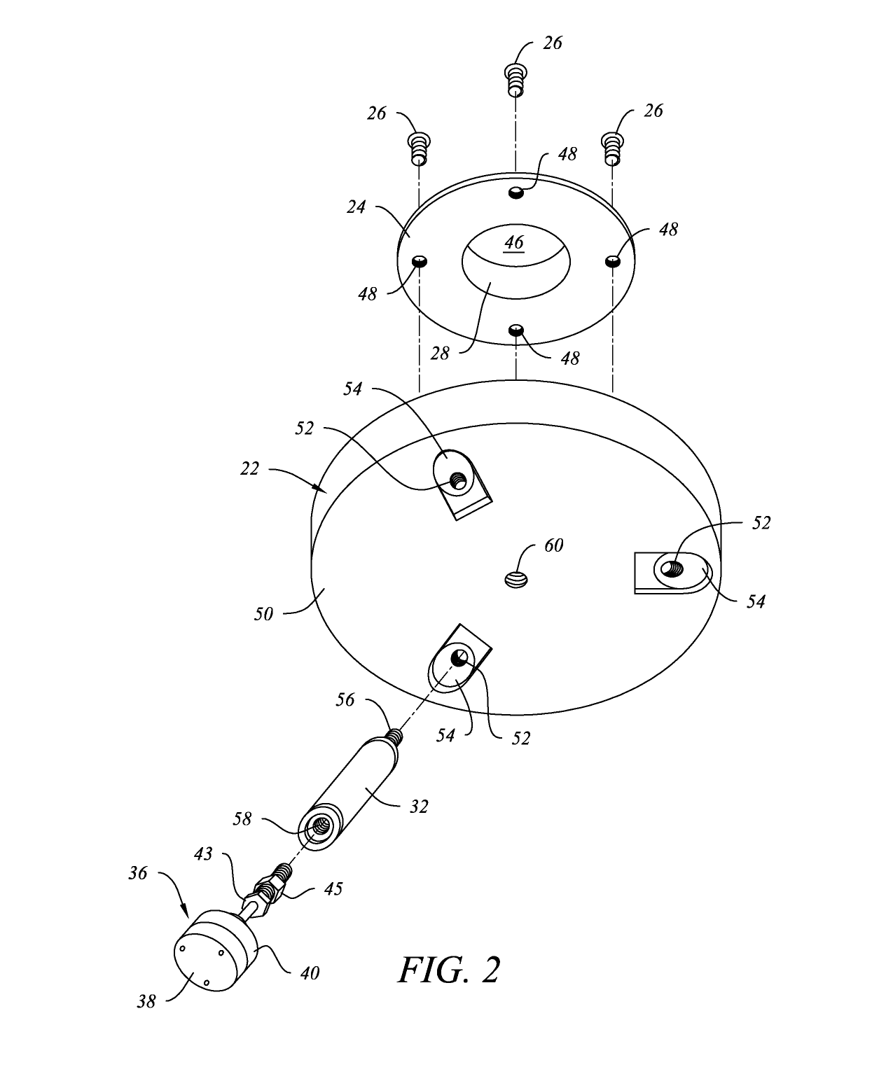

FIG. 1 depicts for illustrative purposes an embodiment of survey tripod assembly 20 of the invention that comprises instrument support plate 22 having survey instrument attachment device 24 further comprising raised threaded section 28. Survey instrument attachment device is secured in releasable fixed relation to instrument support plate 22 by a plurality of spaced-apart fasteners 26. Three tripod legs (one being hidden behind the visible leg on the left) are releasably engaged at fixed predetermined attachment angle to instrument support plate 22 by externally threaded bolts 44 that extend through internally threaded bores 52 in receptacles 54 on the underside of instrument support plate 22 that are visible in FIG. 2.

Referring again to FIG. 1, for illustrative purposes, each tripod leg is depicted with leg sections partially broken away. It should be understood, however, that upper leg section 32 and lower leg section 34 can be the opposite end parts of a single leg section or can be upper and lower end parts, respectively, of different leg sections, each of different lengths. The leg sections 32 (now used generically) are each cooperatively configured to releasably engage other leg sections and can be joined to produce a tripod leg of greater length than any single section. Each tripod leg can comprise one or a plurality of leg sections, depending upon the operational height that is desired for a survey instrument (as shown in dashed outline in FIG. 1) being used in a particular application or environment.

Also depicted in FIG. 1 are two of the three swiveling adjustable feet 36 that provide stable contact between each tripod leg and an underlying support surface (not shown). Although the method of attachment of the adjustable swiveling feet 36 to the lower leg section 34 can vary, in this embodiment swiveling ball 42 is captured by ball housing 40 secured to base 38 that desirably comprises a non-slip lower surface. A limited degree of height adjustability for uneven support surfaces is provided by threaded bolts 43, 45 attached to mounting shafts fixed to swiveling balls 42. In situations where a very low operational height for instrument support plate 22 is desired, threaded bolt 45 can be attached directly to instrument support plate 22 without using any leg sections 32, 34, so that each tripod leg comprises only a swiveling adjustment foot 36.

FIG. 2 is an exploded lower perspective view of survey tripod assembly 20 of FIG. 1 view that is helpful for visualizing how the constituent parts are configured and assembled. (It should be noted that FIGS. 1 and 2 are not drawn to scale, and that only one leg section 32 of one tripod leg is depicted for illustrative purposes.) Referring to FIG. 2, it is seen that swiveling adjustment foot 36 comprising ball housing 40 and base 38 is releasably secured to the lower end of leg section 32 by cooperatively threaded adjustment bolt 43 and threaded attachment bolt 45. The male threaded upper portion of attachment bolt 45 is configured to be received into and provided threaded engagement with cooperating female threads inside the bore of insert 58 disposed inside the bottom of tubular leg section 32. Threaded adjustment bolts 43 and threaded attachment bolts 45 (only one being shown in FIG. 2) are useful for attaching each swiveling adjustment foot 36 to a leg section 32 (or directly to the underside of instrument support plate 22 if desired to achieve the lowest possible operational height without using any leg section 32) and for leveling instrument support plate 22 to gravity. With this configuration, leveling instrument support plate 22 to the nearest arc-second is achievable.

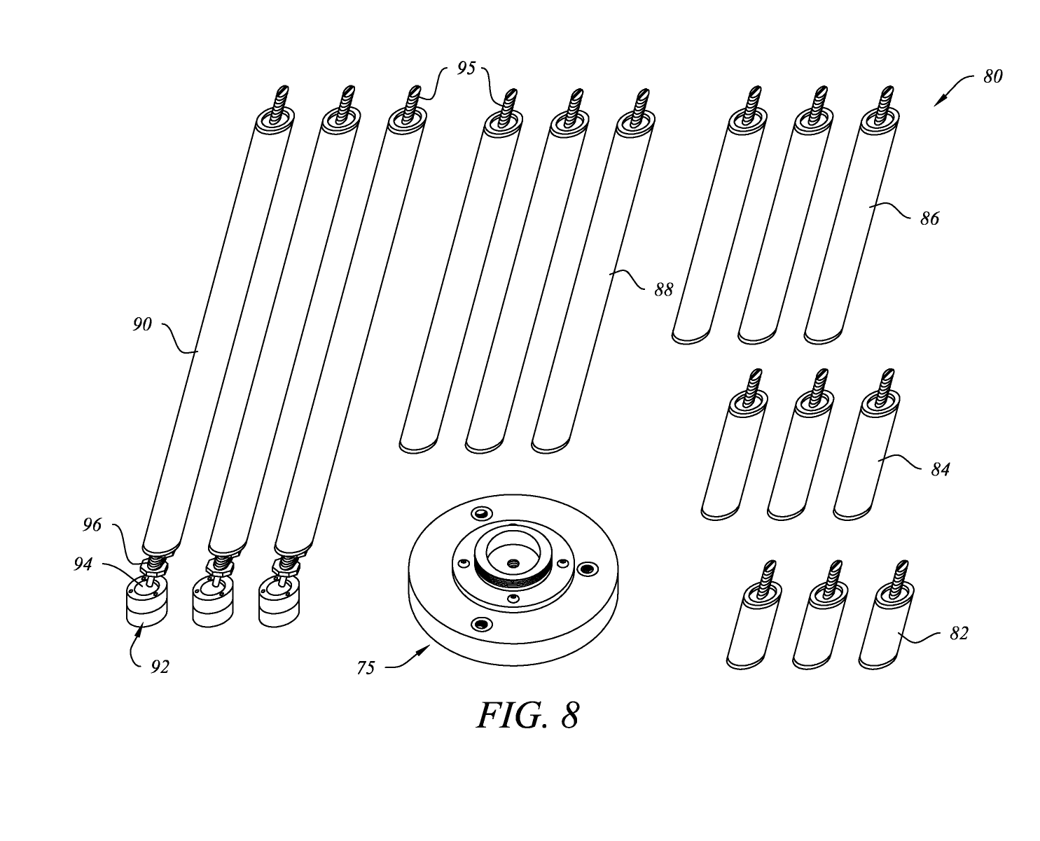

Upwardly extending male threaded bolt 44 of insert 64 (FIGS. 6-7, discussed below) at the upper end of tubular leg section 32 is desirably provided for use in releasably attaching leg section 32 of the associated tripod leg to the horizontally level instrument support plate 22 at a predetermined attachment angle. This releasable attachment can be achieved, for example, by providing a plurality of evenly spaced-apart receptacles 54 in bottom 50 of instrument support plate 22, with each receptacle 54 desirably having female threaded through-bores 52 that are drilled in evenly spaced-apart circumferential relation to the center of instrument support plate 22 at a desired predetermined attachment angle that is the same for each through-bore 52. The attachment angle is desirably chosen to provide a desired spread between the tripod legs and swiveling adjustable feet 36 at the base of the subject survey tripod assembly 20. Although the attachment angle can vary within the scope of the invention, an attachment angle of about 22 degrees from vertical, plus or minus up to about 5 degrees, can be utilized satisfactorily for most survey tripods intended for general use. For specialized applications or designs, other acute attachment angles may be preferred. The inside surface of each receptacle 54 is desirably configured to provide stable contacting engagement with each leg bolt 44 (when used with leg sections 32), insert 64, or threaded adjustment bolt 45 (where no leg section 32 is used), so that no unintended significant relative movement occurs between instrument support plate 22 and the tripod legs. It will be appreciated upon reading this disclosure that the distance of the spread between the three tripod legs of survey tripod assembly 20 can vary according to the overall length of each assembled tripod leg, which will in turn depend upon the number and length of the leg sections used in each tripod leg, as is further discussed below.

A significant advantage of survey tripod assembly 20 as compared to those disclosed in the prior art is the ability to easily and conveniently adjust the operational height of the instrument support plate 22 for a particular use. This is generally achieved by selecting different numbers and lengths of leg sections 32 when assembling the tripod legs, although the overall length of the assembled leg sections 32 and the predetermined attachment angle at which the tripod legs are attached to instrument support plate 22 will both affect the operational height of tripod assembly 20.

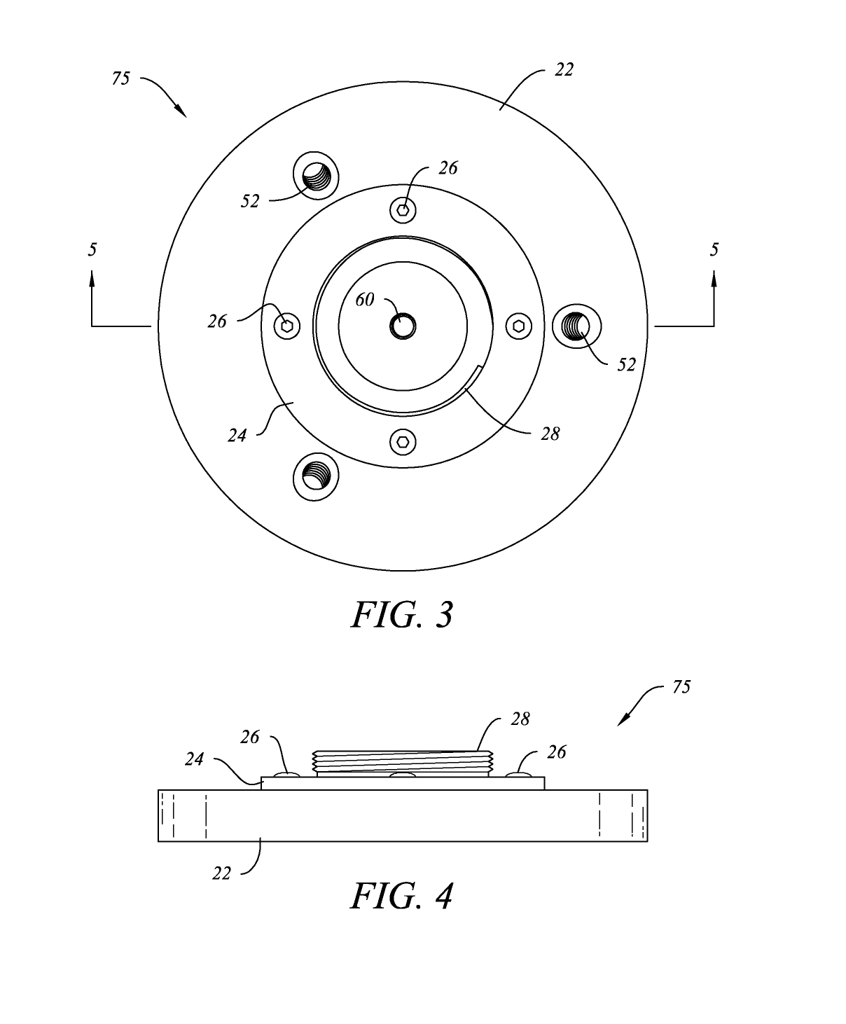

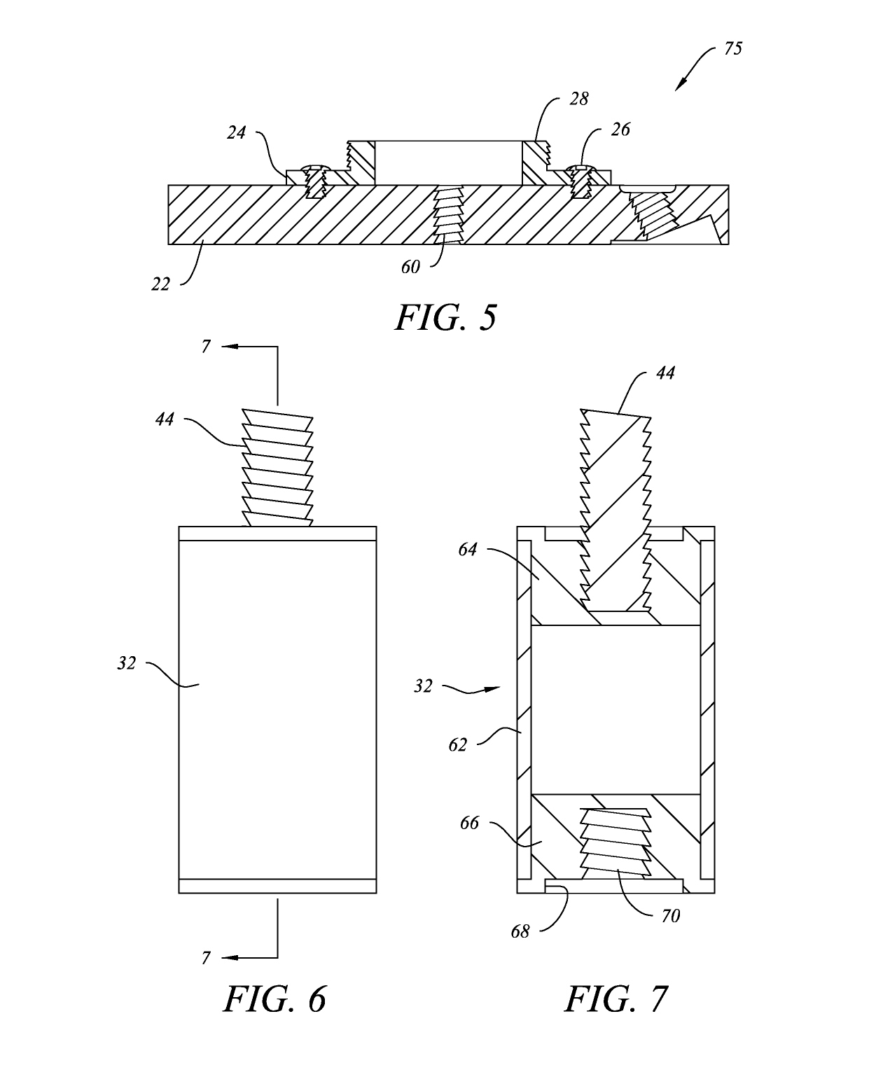

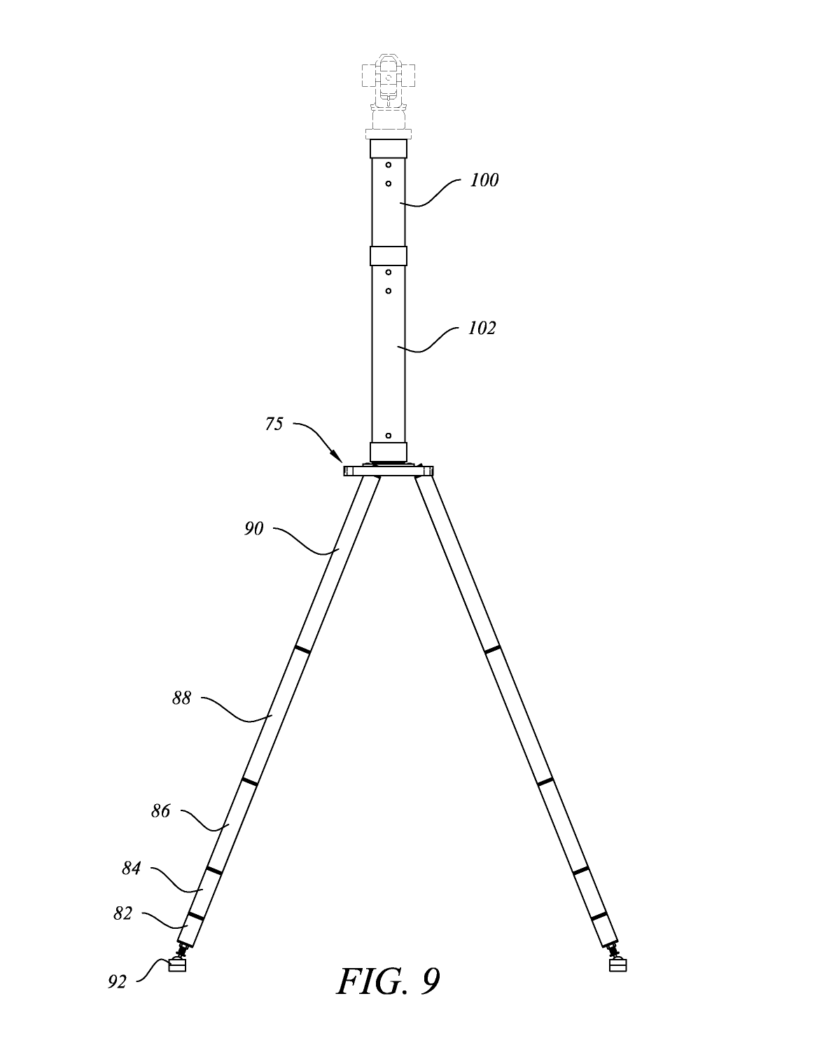

Referring to FIGS. 2-5, survey instrument support device 24 is desirably a metal plate lesser in thickness than instrument support plate 22 and further comprises a plurality of circumferentially spaced apertures 48 through which male threaded fasteners 26 can be inserted for attachment to correspondingly threaded female bores (not visible in FIG. 2 but visible in FIG. 5) in the upwardly facing surface of instrument support plate 22. Reference numeral 75 is used in FIGS. 2-5, 8 and 9 to designate the assembled unit formed when survey instrument attachment device 24 is secured to instrument support plate 22. As seen in FIG. 3, fasteners 26 are flat-headed Allen screws that do not interfere with the subsequent mounting of a survey instrument. Centrally disposed, internally threaded through-bore 60 is provided in instrument support plate 22 for possible insertion of a mounting screw for a survey instrument or for possible use in determining whether the instrument support plate 22 is plumb with an underlying support surface. As best seen in FIGS. 1 and 4-5, survey instrument support device 24 preferably further comprises an upwardly facing male threaded collar 28 for possible use in attaching either a downwardly facing female threaded attachment collar of a survey instrument (as suggested by the dashed outline in FIG. 1) or for attaching a vertical extension member 102 as shown in FIG. 9 for use in positioning a survey instrument in a higher position relative to the top of a survey tripod assembly 20 (FIG. 1) of the invention.

Referring to FIGS. 6-7, a typical leg section 32 for use in the invention is further described. According to one embodiment of the invention, leg section 32 is constructed from a tubular sleeve 62 that is preferably made of lightweight metal such as aluminum or another metal alloy such as brass, bronze, boron, titanium or the like. Strength and rigidity are desirable for use in fabricating the leg sections, but cost and weight are also significant considerations. Although wood, stainless steel or engineered polymeric materials can also be used for making the elongate body portions of leg section 32, the use of aluminum sleeves 62 with press-fit stainless steel inserts 64, 66 is presently considered to be a satisfactory way of constructing leg sections such as leg section 32. For longer leg sections, other internal reinforcement structures known to those of skill in the art can also be used. Externally threaded bolt 44 is desirably provided at one end of each leg section of the invention as represented by leg section 32, and internally threaded bore 70 is desirably provided at the other end. The bolts and bores for the leg sections are desirably configured and made of materials that will provide tight engagement but release relatively easily without use of tools, and can remain serviceable over long periods of regular use without significant wear or degradation. Recesses 68 (FIG. 7) can also be provided at one or both ends of leg sections 32 to facilitate the possible use of washers, bushings or compressible materials between adjacent leg sections or between a leg section and the instrument support plate or a swiveling adjustable foot if desired.

Referring to FIG. 8, one embodiment of a survey tripod assembly kit 80 is depicted that comprises a unit 75 comprising an assembled instrument support plate and survey instrument attachment plate as described above, and five different sets 82, 84, 86, 88, 90 of leg sections. Each set contains three leg sections of the same length, but the length of the leg sections in different sets is different. The number of sets in each tripod assembly or kit can vary, but should include a plurality of sets and desirably from at least three to at least five sets. At least three leg sections of the same length should be included in each set so that three tripod legs of equal length can be assembled using leg sections from any set or combination of sets.

As depicted in FIG. 8, a swiveling adjustment foot 92 comprising a swiveling ball 94 and a threaded adjustment bolt 96 is pre-attached to the bottom end of each leg section in set 90. It will be appreciated, however, that the swiveling adjustable feet 92 can be packed and transported while detached from any of the leg units if desired. A male threaded attachment bolt 95 projects upwardly from the other end of each leg section of each set 82, 84, 86, 88, 90, although it should be understood that other similarly effective, coaxially aligned attachment means can also be substituted for the threaded connectors if desired. For purposes of this invention, it is important, however, that each leg section be selectively attachable to another leg section or to the instrument support plate or to a swiveling adjustment foot as desired or needed when assembling the tripod legs to produce three tripod legs, typically of co-equal length, for use in the survey tripod assembly 20 (FIG. 1) of the invention. The various elements of survey tripod assembly kit 80 can be conveniently packed in a bag, suitcase-type carrier or other similarly effective container for transport and storage between uses.

It is emphasized that the number of sets of leg sections can vary within the scope of the invention. All leg sections will not necessarily be used in every application of the subject survey tripod assembly 20 or survey tripod assembly kit 80, and in some cases, no leg sections 32 will be used. Referring to FIG. 9, a survey tripod assembly of the invention is depicted that comprises unit 75 comprising an instrument support plate and a survey instrument attachment device as previously described, and three tripod leg assemblies (two of which are visible). Each tripod leg assembly comprises five leg sections of different, unequal lengths, consisting of one leg section from each of the plurality of sets 82, 84, 86, 88, 90. It will be appreciated upon reading this disclosure that survey tripod assemblies 20 having different operational heights can be assembled from a single kit 80 by selecting leg sections only from the sets having lengths needed to reach the desired overall length for each tripod leg. Although the tripod leg assemblies will typically need to be of equal lengths for a particular combination, a combination of one, two, three, four, five or more leg sections, each from a different set (or, alternatively, simply a swiveling adjustment foot 92) may be needed to achieve a tripod leg assembly having the desired overall length. The order of assembly of the different-length leg sections 82-90 of each tripod leg does is not critical even though the tripod legs are depicted in FIG. 9 as decreasing from longest to shortest from top to bottom. For most purposes, it has been found that sets having leg section lengths (when assembled) of 3, 5, 10, 20 and 30 inches, with three leg sections of each length in a given set, are adequate for assembling stable survey tripods with operational heights ranging from a few inches to more than five feet in increments of 2-3 inches, even without the use of vertical extension members 100, 102 disposed above unit 75. For example, three tripod legs of 35 inches overall length (without considering the swiveling adjustable foot) can be made by using three leg sections of 20, 10 and 5 inches for each leg, or leg sections of 30 and 5 inches for each leg, or a mixture of the two. Because each leg, when attached to the instrument support plate, will be disposed at a slight angle from vertical in order to obtain a spread of the legs, the operational height of the tripod assembly may be somewhat less or more than 35 inches when the thickness of the plate and the height of the foot is also added. For survey tripod assemblies designed specifically for particular intended uses, the number of sets of leg sections and the length of the leg sections in each set can vary within the scope of the invention. As disclosed above, it is not required in some situations that any leg section be used in making the survey tripod assembly of the invention.

Again referring to FIG. 9, the useful height of the subject survey tripod assembly can be further extended upwardly by the use of one or more vertical extension members 100, 102 of various lengths that are attachable to both unit 75 and a survey instrument (shown in dashed outline).

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor and Applicant is legally entitled.

What is claimed is:

1. A survey tripod assembly kit comprising an instrument support plate and three tripod leg assemblies, each tripod leg assembly comprising at least one swiveling adjustable foot and further comprising a plurality of cooperatively engageable leg sections each having first and second ends; wherein the cooperatively engageable leg sections comprise at least three sets of leg sections of different lengths, with each set of leg sections comprising three leg sections having the same length; and wherein each end of each leg section is configured to be releasably attachable to either end of another leg section of a different length, to the instrument support plate, or to one of the three swiveling adjustable feet.

2. The survey tripod assembly kit of claim 1 comprising at least four sets of leg sections of different lengths.

3. The survey tripod assembly kit of claim 2 comprising at least five sets of leg sections of different lengths.

4. The survey tripod assembly kit of claim 1 wherein each end of each leg section is configured to be releasably attached in threaded engagement with any other leg section in a different set of leg sections.

5. The survey tripod assembly kit of claim 1 wherein each end of each leg section and each swiveling adjustable foot is configured to be releasably attached in threaded engagement with the instrument support plate.

6. The survey tripod assembly kit of claim 1 wherein each end of each leg section is configured to be releasably attached in threaded engagement with a swiveling adjustable foot.

7. The survey tripod assembly kit of claim 1 wherein the instrument support plate further comprises a survey instrument attachment device that is releasably attachable to a survey instrument.

8. The survey tripod assembly kit of claim 1 wherein the instrument support plate comprises three threaded receptacles that are each releasably engageable with a tripod leg section at a predetermined attachment angle.

9. The survey tripod assembly kit of claim 8 wherein the predetermined attachment angle ranges from about 17 to about 27 degrees from vertical.

10. The survey tripod assembly kit of claim 9 wherein the predetermined attachment angle is about 22 degrees from vertical.

11. The survey tripod assembly kit of claim 1, further comprising at least one vertical extension member releasably engageable with the instrument support plate to elevate a survey instrument above the instrument support plate.

12. The survey tripod assembly kit of claim 11 comprising a plurality of threadedly engageable vertical extension members, at least one of which is threadedly engageable with the instrument support plate.

13. The survey tripod assembly kit of claim 8 wherein the length of the leg sections in each set of leg sections, the length and number of leg sections selected for assembly into each of the three tripod legs, and the predetermined attachment angle of each tripod leg to the instrument support plate are selected to make a survey tripod assembly having an overall height that is within a desired predetermined range of heights.

14. The survey tripod assembly kit of claim 3 comprising five sets of leg sections wherein the leg sections in each of the five sets have assembled lengths of 3 inches, 5 inches, 10 inches, 20 inches and 30 inches, respectively.

15. The survey tripod assembly kit of claim 14 wherein leg sections selected from the five sets of leg sections can be assembled to produce three tripod legs of equal length ranging from 3 inches to 68 inches.

16. The survey tripod assembly kit of claim 14 wherein leg sections selected from the five sets of leg sections can be assembled to produce survey tripods having heights that differ in increments of between about two and three inches, depending upon the angle of attachment of each tripod leg to the instrument support plate.

17. The survey tripod assembly kit of claim 14 wherein leg sections can be selected and cooperatively attached to form three tripod legs of equal lengths of 3 inches, 5 inches, 8 inches, 10 inches, 13 inches, 15 inches, 18 inches, 20 inches, 23 inches, 25 inches, 28 inches, 30 inches, 33 inches, 35 inches, 38 inches, 40 inches, 43 inches, 45 inches, 48 inches, 50 inches, 53 inches, 55 inches, 58 inches, 60 inches, 63 inches, 65 inches and 68 inches, respectively.

18. The survey tripod assembly kit of claim 1 wherein at least some of the leg sections comprise tubular walls and threaded ferrous metal inserts.

19. The survey tripod assembly kit of claim 17 wherein at least some of the threaded ferrous metal inserts are made of stainless steel.

20. The survey tripod assembly kit of claim 1 wherein the swiveling adjustable feet have bases configured to reduce slippage between the feet and an underlying substrate.

21. A survey tripod assembly made from a survey tripod assembly kit comprising an instrument support plate, three swiveling adjustable feet, and a plurality of cooperatively engageable leg sections each having first and second ends; wherein the swiveling adjustable feet and cooperatively engageable leg sections are configured for assembly into three tripod legs and include at least three sets of leg sections of different lengths, with each set of leg sections comprising three leg sections having the same length; and wherein each end of each leg section is configured to be releasably attachable to either end of another leg section of a different length, to the instrument support plate, or to one of the three swiveling adjustable feet.

22. The survey tripod assembly of claim 21 wherein the survey tripod assembly kit comprises at least four sets of leg sections.

23. The survey tripod assembly of claim 22 wherein the survey tripod assembly kit comprises at least five sets of leg sections.

24. The survey tripod assembly of claim 21 wherein each leg section is releasably attachable to the instrument support plate at a predetermined attachment angle.

25. The survey tripod assembly of claim 21 wherein the survey tripod assembly kit further comprises at least one vertical extension member releasably attachable to the instrument support plate.
